(19) United States
(12) Patent Application Publication
(10) Pub. No.: US 2014/0048167 A1
(43) Pub. Date: Feb. 20, 2014

(54) Rectangular Sheet Metal Sealed Duct

(71) Applicant: Ductmate Industries, Inc., East Monongahela, PA (US)

(72) Inventors: Douglas G. Gudenburr, Finleyville, PA (US); Alvin L. Jefferson, Pittsburgh, PA (US); David E. Overdorff, II, Ruffs Dale, PA (US)

(73) Assignee: Ductmate Industries, Inc., East Monongahela, PA (US)

(21) Appl. No.: 13/965,755

(22) Filed: Aug. 13, 2013

Related U.S. Application Data
(60) Provisional application No. 61/682,956, filed on Aug. 14, 2012.

(51) Int. Cl. F16L 23/14; F24F 13/02

(52) U.S. Cl. CPC F16L 23/14; F24F 13/0209
USPC 138/155; 285/363

(57) ABSTRACT

A rectangular cross-section sheet metal duct system that is automatically sealed when assembled prevents or reduces leakage of air from the duct system.

### CROSS-REFERENCE TO RELATED APPLICATIONS

This application claims the benefit of U.S. Provisional Application No. 61/682,956, filed Aug. 14, 2012 and which is hereby incorporated by reference in its entirety.

### STATEMENT REGARDING FEDERALLY SPONSORED RESEARCH OR DEVELOPMENT

Not Applicable

### INCORPORATION-BY-REFERENCE OF MATERIALS SUBMITTED ON A COMPACT DISK

Not Applicable

### BACKGROUND OF THE INVENTION

Rectangular cross-section sheet metal ducts have been in use for many years to conduct heated or cooled air from furnaces or air conditioners to registers in residential or light commercial buildings. In recent years, an emphasis has been placed on efficiently sealing the ducts to prevent leakage of conditioned air. Since residential and light commercial buildings ordinarily do not require the relatively heavier ductwork used in commercial or industrial buildings, it is sensible to work toward lighter weight ductwork that is effectively sealed.

The present invention is directed to providing light weight ductwork that is completely sealed automatically when it is assembled. Rather than have heavy corner pieces bolted together to hold the rectangular duct sections in alignment, the present invention has automatically sealed components that both seal and align the duct sections.

### BRIEF SUMMARY OF THE INVENTION

The present invention provides a light weight, rectangular cross-section sheet metal duct system for conducting conditioned air from a furnace or air conditioner or for conducting air from a room. The rectangular sheet metal duct sections are formed at a standard specific length. Flanges are roll-formed on the duct sections with the flanges having a perpendicular face extending away from the walls of the duct section and a parallel face extending parallel to the walls of the duct sections.

A gasketing material is affixed to the perpendicular faces of the flanges during the latter stages of manufacturing the duct sections. Flexible corner pieces are inserted to seal the corners of the ducts where the flanges do not meet each other with one corner piece sealing two mating duct sections. The duct system is automatically sealed when a flange with gasketing material attached is placed in contact with a flange of a mating duct section. After the two duct sections are in contact with each other and with the corner pieces, drive cleats are placed over the flanges to hold the automatically sealed system together.

In order to reduce the weight of the present duct construction, the flanges have a perpendicular face dimension “x” between the duct wall and the parallel flanges of no more than 0.5 of an inch.

### BRIEF DESCRIPTION OF THE DRAWINGS

FIG. 1 is a perspective view of one duct section of the present invention.

FIG. 1A is an enlarged portion of the corner area of FIG. 1.

FIG. 1B is a perspective view of the novel corners piece of FIGS. 1 and 1A.

FIG. 2 is a top plan view of two duct sections of the present invention before they are joined together.

FIG. 3 is a perspective view of two duct sections of the present invention joined together, but before the cleats are added.

FIG. 4A is a perspective view of two joined duct sections with the cleats added.

FIG. 4B is a cross section of FIG. 4A.

FIG. 5 is a side view of an installed rectangular duct.

### DETAILED DESCRIPTION

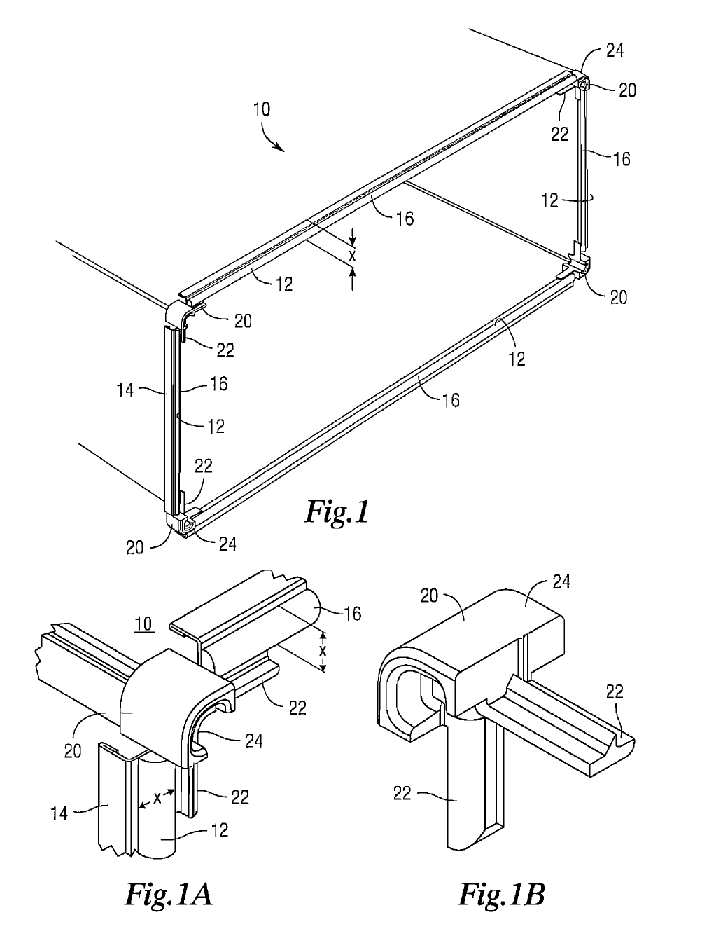

Referring to the drawings, and particularly to FIG. 1, FIG. 1A and FIG. 1B, there is shown a rectangular cross-section duct section 10 having flanges with a perpendicular face 12 and a parallel face 14 formed on the duct section. The flanges 12 and 14 are preferably formed by roll-forming equipment and as part of the manufacturing process, gasketing material 16 is affixed to perpendicular face 12.

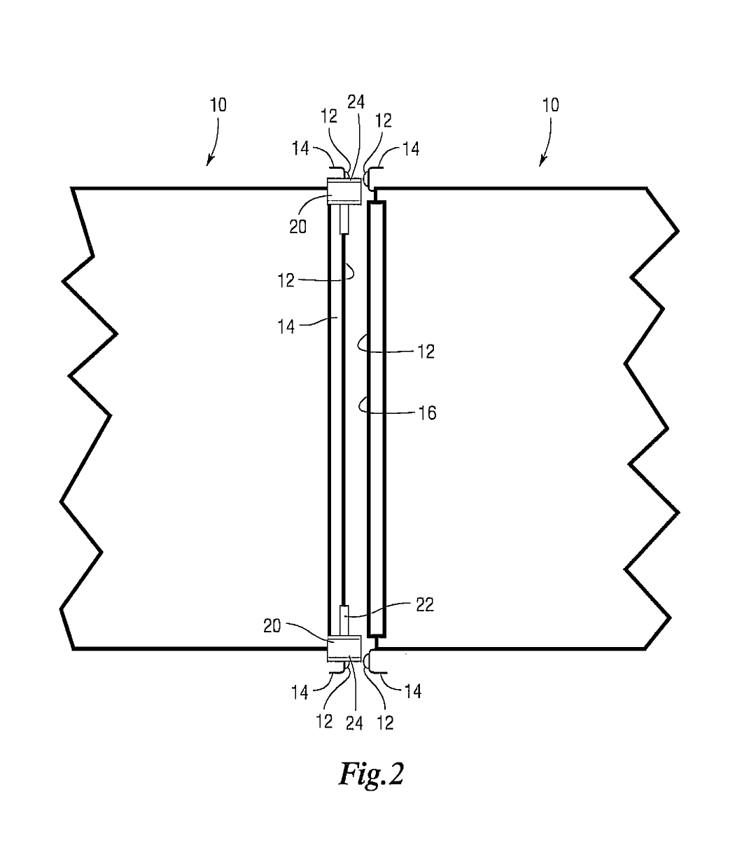

When the flanges 12 and 14 are directly roll-formed on the duct sections 10, there are gaps at the corners between the flanges which must be sealed. Corner pieces 20 are formed of flexible heat resistant material such as rubber or plastic to fill the voids between the flanges and to seal the corners of the rectangular ductwork. As best seen in FIG. 1A, FIG. 1B and FIG. 2, the corner pieces 20 have an underlying portion 22 which contacts the inside wall of the duct and a protruding portion 24 that extends outwardly between the flanges in order to ensure a sealed connection. Prior to this invention, corner pieces were used to connect the ducts together and did not have a sealing function as they were rigid metal and not capable of that function. The corners of this invention reduce air loss by providing a sealing surface. The improvement would include any loss of air less than when a metal corner piece is used. The flexible material will also reduce the noise of the ductwork when air is passing through it.

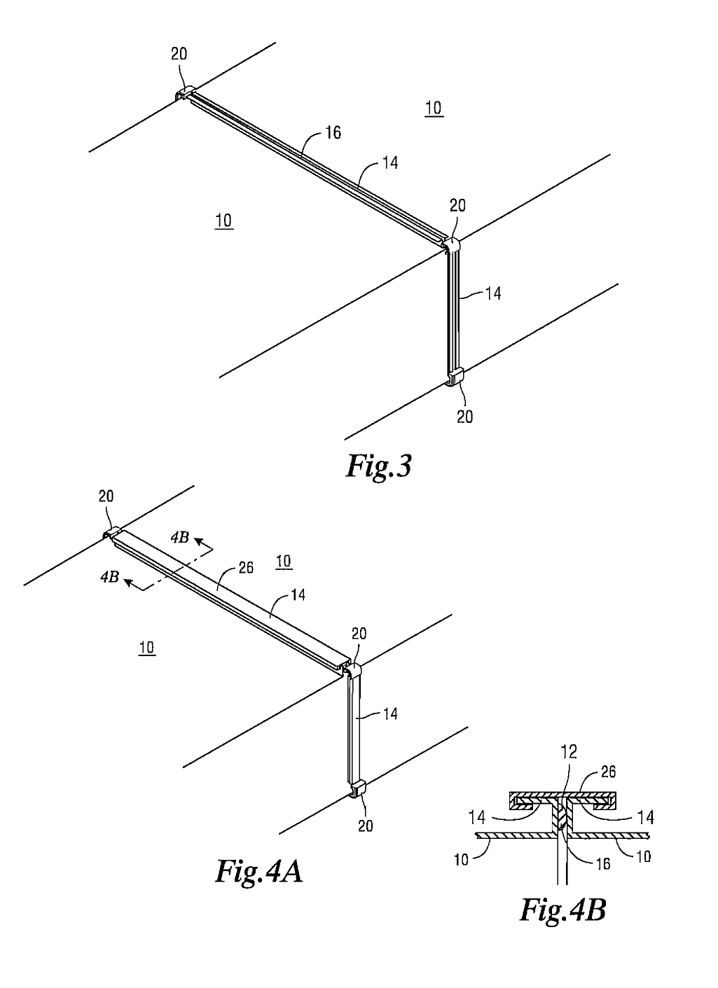

FIG. 3 shows two duct sections assembled so that the perpendicular walls 12 are in contact with each other and the corner pieces 20 fill the area between the flanges. In assembly of the duct system, the corner pieces 20 are first snapped into the four corners of one duct section and when the second duct section is brought into contact with the first, all the duct corners are sealed. After the assembly shown in FIG. 3, drive cleats 26 are added, as shown in FIG. 4, to hold the flanges of adjacent duct sections together. As shown in FIG. 1 and FIG. 1a, the dimension of the height of the perpendicular flange 12 as indicated at “X”. That dimension does not exceed 0.5 of an inch so as to keep the profile of the duct low and keep unnecessary weight out of the construction.

It will be seen that with the gasketing material 16 on the perpendicular face 12 of the flange and with the corner pieces 20 inserted in place, the duct sections 10 are automatically sealed to each other without additional labor to add tape or paint joints to create an additional seal.

The gasketing material can either be a liquid applied or a tape applied gasket. If it is a tape applied gasket, examples include pressure sensitive foam tapes and gaskets including but not limited to polyethylene foam. Other examples include Ductmate 440 Gasket Tape (isobutylene) or any other butyl gasket. Additional examples include Gasket Tape Neoprene/Urethane and EPDM Gaskets. The applied gasket would be after the duct is formed and then it would be cut and applied by an automated process.

With respect to liquid applied gasketing material, reference can be made to U.S. Pat. No. 7,992,904 by Bloom et al., “Sealing Mechanism for Ductwork” for the properties of the material and application of the material, the teachings of which are hereby incorporated by reference in its entirety. An example of the material that can be used is Loctite Nuva Sil 5039 and preferably it is foamed. It can be foamed by a Nordsen Ultra Foam Machine. While the material properties and the type of material is the same as U.S. Pat. No. 7,992,904, the application is different as the subject matter of this Application is rectangular ductwork. For example, a v-groove is placed in the flange during the roll-forming. This v-groove is not necessary in the tape application. Typical steps for applying the gasketing material with this invention are as follows:
1) Apply primer on sheet metal to what will be a flange face when roll-formed;
2) Roll-form the flange, a v-groove during the roll-forming process of making a L-section;
3) Automated arm rotates L section 90 degrees to horizontal position;
4) Apply gasket material in v-groove. One needs to consider flow rates and the amount added as well as other factors; and
5) Allow time for gasket material to cure.

By having a gasketing material 16 affixed to the flange 12 and/or a corresponding flange on the other adjoining duct (the material can be added to one duct or both ducts) during the manufacturing process, the assembly of the ductwork in a sealed condition is facilitated. Because of the narrow flanges 12 (0.05 of an inch or less) it would very difficult and time consuming to have the installer insert a standalone gasket between the flanges of adjoining duct sections 10. The gasketing material must adhere to one of the flanges in order to be able to position the corner pieces 20 to seal both adjacent duct sections 10. The sealant also reduces the noise.

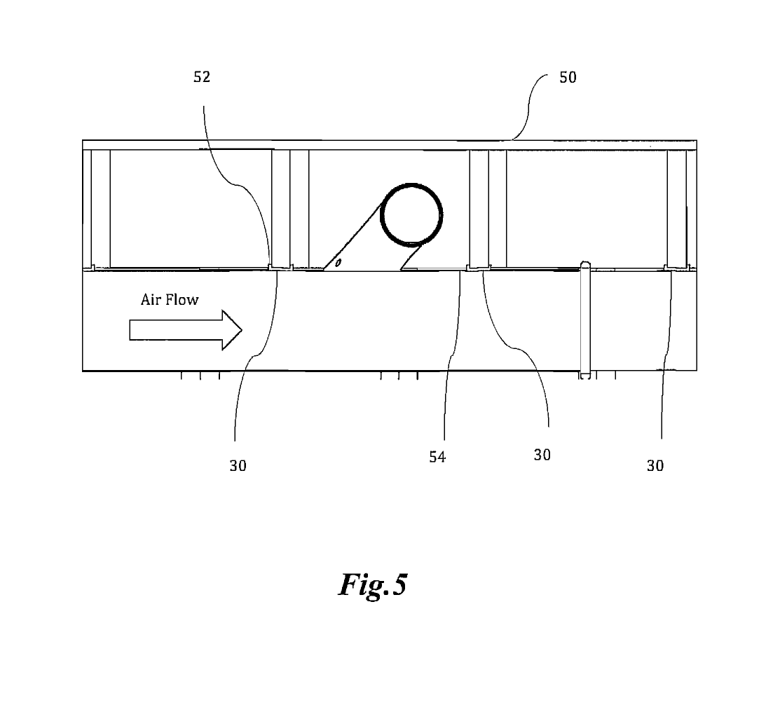

As shown in FIG. 5, this invention also contemplates a vibration isolator 30. The vibration isolator 30 is located between the bottom of the joists 52 and a top of the duct 50. The vibration isolator's 30 typical dimensions are 1″ wide by 4″ long by 1″ thick. The material can be neoprene, with a glue backing on one side, to fasten the isolator to the ceiling joist. Other types of vibration/noise isolator materials can be used.

Various changes could be made in the above constructions and method without departing from the scope of the invention as defined in the claims below. It is intended that all matter contained in the above description, as shown in the accompanying drawings, shall be interpreted as illustrative and not limiting.
10 light weight sheet metal duct section
12 perpendicular face of flanges
14 parallel face of flanges
16 gasketing material affixed to 12
20 corner piece
22 underlying portion of 20
24 protruding portion of 20
26 drive cleats
30 vibration isolator
50 top of the duct
52 bottom of the joists

I claim:

1. A rectangular sheet metal duct system for conducting conditioned air from a furnace or air conditioner or conducting air from a room comprising:
(a) rectangular sheet metal duct sections of a specific length;
(b) flanges roll-formed on the ends of the duct sections with the flanges having a perpendicular face extending away from the walls of the main body of duct sections and a parallel face extending parallel to the walls of the main body of duct sections;
(c) gasketing material affixed to the perpendicular faces of the flanges during the manufacturing process and prior to shipment;
(d) flexible sealing corner pieces inserted to seal the corners of the ducts where the flanges do not meet each other with one corner piece sealing two mating ducts;
(e) the rectangular sheet metal duct system being automatically sealed when a flange with gasketing material attached is put in contact with a flange of a mating duct section and the two duct sections contact the flexible corner pieces at the four corners of the duct sections; and
(f) drive cleats are placed over mating duct section flanges to hold the duct system together.

2. The rectangular sheet metal duct system of claim 1 wherein the height of the perpendicular flanges between the duct section main body and the parallel flanges does not exceed 0.5 inches.

3. The rectangular sheet metal duct system of claim 1 wherein portions of the flexible corner pieces extend under the walls of the main bodies of the duct sections and another section protrudes above the main bodies of the duct sections in the areas at the corners where there are no flanges.

4. The rectangular sheet metal duct system of claim 3 wherein the longitudinal seams of the rectangular sheet metal duct sections contain sealant to seal the entire duct system.

5. The rectangular sheet metal duct system of claim 1 wherein the component parts may be shipped either assembled or disassembled, but when assembled form an automatically sealed rectangular sheet metal duct system without the installer having to apply sealant.

6. A corner for a rectangular sheet metal duct system comprising:
(a) curved body generally creating a 90 degree angle;
(b) a first end on the curved body to abut a cut out end of rectangular duct;
(c) a second end on the curved body to abut a second cut out end of a rectangular duct so that when in place it creates a corner;
(d) a first leg having a reduced thickness from the body extending from the first end that abuts an interior flange of the sheet metal duct when in place;
(e) a second leg having a reduced thickness from the body extending from the second end that abuts an interior flange of the sheet metal duct when in place;
(f) a ridge in the center of the first leg that provides a sealing surface for the sheet metal duct; and
(g) a ridge in the center of the second leg that provides a sealing surface for the sheet metal duct.

7. A corner as recited in claim 6 wherein it is made of a material that creates seal in the corner.

8. A corner as recited in claim 6 wherein it creates a sealed corner.

9. A corner as recited in claim 6 wherein it completes the gasketing seal around the end of the sheet metal duct when two ducts are connected.

10. The rectangular sheet metal duct system of claim 1 wherein the duct reduces noise and vibration over current sheet metal ducts.

11. A method of manufacturing a self sealing rectangular sheet metal duct comprising:
(a) providing sheet metal;
(b) forming by a roll-former sections of the rectangular duct wherein the ends have a flange; and
(c) applying sealant during manufacturing the flange.

12. The method as recited in claim 11 including forming a v-groove in the flange prior to applying the sealant.

13. The method as recited in claim 11 including applying a primer to the sheet metal.

14. The method as recited in claim 12 wherein the primer is applied prior to roll-forming and only to a section of the sheet metal where the flange will be formed.

15. A method for installing a self-sealing noise reducing rectangular duct:
(a) providing a structure in need of ductwork;
(b) providing rectangular duct sections in which at least one duct has a sealant on an end that was applied during manufacturing;
(c) providing plastic corners that are used in the corners of the duct when the two sections of ducts are joined;
(d) providing cleats to join the two sections of the ducts together; and
(e) joining the ducts together and installing the duct to the structure.

16. The method as recited in claim 15 including providing a vibration isolator that is installed between the duct and the structure in order to reduce noise and vibration when the duct is installed.
